(19) United States
(12) Patent Application Publication
(10) Pub. No.: US 2013/0294977 A1
(43) Pub. Date: Nov. 7, 2013

(54) APPARATUS FOR USE IN PRODUCTION OF NITRIC ACID

(71) Applicants: Anthony Matthew Johnston, Double Bay (AU); Brian Scott Haynes, Frenchs Forest (AU)

(72) Inventors: Anthony Matthew Johnston, Double Bay (AU); Brian Scott Haynes, Frenchs Forest (AU)

(73) Assignees: MEGGIT (UK) LIMITED, Poole Dorset (GB); THE UNIVERSITY OF SYDNEY, Sydney (AU)

(21) Appl. No.: 13/990,950

(22) PCT Filed: Dec. 1, 2011
(86) PCT No.: PCT/AU11/01554

§ 371 Date: Jul. 24, 2013

(30) Foreign Application Priority Data
Dec. 1, 2010 (AU) 2010905287

(51) Int. Cl. B01J 19/00

(52) U.S. Cl. CPC B01J 19/00
USPC 422/162

(57) ABSTRACT

A heat exchange apparatus is disclosed for use in the production of nitric acid and which provides for feed-effluent heat exchange and integrated nitrogen dioxide absorption. The apparatus includes a core structure having first and second groups of diffusion bonded corrosion resistant metal plates having fluid flow channel systems formed therein. A feed-effluent heat exchange system is provided by first channel systems of the first and second groups of plates being juxtaposed in heat exchange relationship and an absorption system is provided by second channel systems of the first and second groups of plates being juxtaposed in heat exchange relationship.

### TECHNICAL FIELD OF THE INVENTION

This invention relates to apparatus for use in the production of nitric acid.

### BACKGROUND OF THE INVENTION

The conventional approach to manufacture of nitric acid, in basic reaction terms, involves a three-stage process comprising, firstly, ammonia oxidation in the presence of air by rapid high temperature catalytic conversion of an ammonia-air mixture to produce nitrogen monoxide. The resultant reaction mixture stream is cooled (under pressure) and some of the nitrogen monoxide reacts non-catalytically with oxygen to form higher oxides of nitrogen such as nitrogen dioxide and its dimer; the mixture of which is referred to below as nitrogen dioxide and the reaction mixture stream as a whole being referred to below as nitrous gas. Following further cooling the nitrous gas is admitted to an absorption process with water and air to produce nitric acid.

The absorption process is performed within a so-called absorption tower, with the product acid concentration typically being between 50% and 68% HNO₃ (w/w), depending upon the operating pressure of, the number of absorption stages in, and the concentration of nitrous gases entering, the absorption tower.

It has now been recognised by the Inventors that, with substantial modification to the manufacturing process, including oxidation of the ammonia in the presence of an oxidising gas, admission of water ballast prior to the ammonia oxidation stage, retention of the water ballast throughout the process and with acceptance of end product in the form of dilute nitric acid (e.g., having a concentration of the order of 20% to 40% HNO₃ (w/w), depending upon the composition of the oxidising gas and the amount of water retained in the reaction mixture stream), an absorption stage may be adopted that utilises heat exchange technology and which obviates the conventional requirement for an absorption tower and its attendant disadvantages. The term “oxidising gas” is to be understood in the context of the present invention as comprising a gas containing more than about 80% (v/v) oxygen and most desirably above 95% (v/v) oxygen.

Various heat exchange technologies (for example, involving shell-and-tube type exchangers, plate type heat exchangers or fin-fan type heat exchangers) might be implemented in the development of an absorption stage that obviates the necessity for an absorption tower, but the Inventors have further recognised that a so-called printed circuit heat exchanger (“PCHE”) construction might with advantage be adapted to the nitric acid manufacturing process. PCHE-type cores currently are employed in heat exchangers in various applications, including for example in the steam-methane reformer as disclosed in Australian Patent 2003201195, granted to Meggitt (UK) Ltd, dated 3 Jan. 2003. The PCHE cores are fabricated by etching channels, having required forms and profiles, into at least one surface of individual stainless steel (or other non-corrosive material) plates which are stacked and diffusion bonded to form structures having dimensions required for specific applications. The small scale of the PCHE passages relative to conventional shell-and-tube exchangers substantially reduces the resistance to heat and mass transfer in an absorption process and provides inherently for a highly compact device.

Thus, the present invention, as below defined, embodies three orders of novelty; firstly the recognition that the conventionally employed absorption towers might be obviated by the adoption of heat exchanger technology, secondly the advantageous adaptation of PCHE-type technology for this purpose and, thirdly, the structuring of a PCHE-type core to provide for integrated feed-effluent heat exchange and nitrogen dioxide absorption.

### SUMMARY OF THE INVENTION

According to one aspect, the invention provides a heat exchange apparatus for use in the production of nitric acid and which provides for feed-effluent heat exchange and integrated nitrogen dioxide absorption. In one embodiment, the apparatus comprises a core structure including first and second groups of bonded metal plates having fluid flow channel systems formed therein, with a feed-effluent heat exchange system comprising first channel systems of the first and second groups of plates juxtaposed in heat exchange relationship and an absorption system comprising second channel systems of the first and second groups of plates juxtaposed in heat exchange relationship. In one embodiment the first and second groups of metal plates are corrosion resistant.

In one embodiment of the invention the first group of plates comprises a plurality of first said plates and the second group of plates comprises a plurality of second said plates. The first and second plates are bonded in face-to-face relationship with the second plates interleaved alternatingly with the first plates. Each of the first plates is formed with separate said first and second channel systems, and each of the second plates is formed with said first and second channel systems connected serially in fluid passage communication. The first and second channel systems of the second plates are juxtaposed in heat exchange relationship with the first and second channel systems respectively of the first plates.

In one operative mode, the apparatus may be defined as comprising a core structure including a plurality of first and second corrosion resistant metal plates bonded in face-to-face relationship, with the second plates being interleaved alternatingly with the first plates. Each of the first and second plates is formed with separate first and second channel systems, with the first channel system of the first plates being arranged to receive aqueous ammonia and an oxidising gas and to deliver a steam-ballasted ammonia-oxygen, and the second channel system of the first plate being arranged to be connected in series with a coolant fluid supply. Each of the second plates also is formed with first and second channel systems that are juxtaposed in heat exchange relationship with the first and second channel systems respectively of the first plates; with the first and second channel systems of each of the second plates being connected serially in fluid passage communication, and with the first channel system being arranged to receive hot nitrous gas and the second channel system being arranged to deliver nitric acid pursuant to progressive oxidation and water condensate absorption of the nitrous gas during transport through the first and second channel systems of the second plates.

Thus, when connected in a nitric acid producing circuit, the first channel system of each of the first plates might typically be arranged to receive aqueous ammonia and an oxidising gas such as oxygen, and to deliver a steam-ballasted ammonia-oxygen feed, and the second channel system of each of the first plates might be arranged to be connected in series with a coolant fluid supply. Then, the first channel system of each of the second plates might typically be arranged to carry hot nitrous gas and the second channel system of each of the second plates may be arranged to deliver nitric acid pursuant to progressive oxidation and water condensate absorption of the nitrous gas during transport through the first and second channel systems of the second plates.

The first and second plates of each (first and second) group of metal plates may, for example, comprise stainless steel plates, and the plates may be bonded face-to-face by diffusion bonding, although other bonding processes, for example brazing, may be employed.

In a complete nitric acid processing plant, the core structure of the above defined apparatus will be connected, for example by headers or directly by conduits, to supplies of an oxidising gas (typically 80% to 95%+(v/v) oxygen), ammonia and water. Also, the apparatus will be connected in circuit with an oxidiser (also referred to as a combustor) device in which, in one embodiment of the processing plant, the ammonia within the steam-ballasted ammonia-oxygen (gaseous oxidiser) feed from the core structure is subjected to high temperature, selective, catalytic conversion to nitrogen monoxide for return, via ancillary devices, to the core structure as a (nitrous gas) reaction mixture feed. The water may be delivered to the apparatus as steam or predominantly in liquid form, and may be delivered with the ammonia (i.e., as aqueous ammonia).

In another embodiment, an apparatus for use in the production of nitric acid is provided which comprises a core structure including a plurality of first and second corrosion resistant metal plates bonded in a face-to-face relationship, with the second plates being interleaved alternatingly with the first plates. Each of the first plates is formed with the separate first and second channel systems, with the first channel system of the first plates being arranged to receive aqueous ammonia and an oxidising gas (such as oxygen) and deliver a steam-ballasted ammonia-oxygen feed, and the second channel system of the first plate being arranged to be connected in series with a coolant fluid supply. Each of the second plates is formed with the first and second channel systems that are juxtaposed in heat exchange relationship with the first and second channel systems respectively of the first plates. Further, the first and second channel systems of each of the second plates is connected serially in fluid passage communication, with the first channel systems of the second plates being arranged to receive hot nitrous gas and the second channel systems being arranged to deliver nitric acid pursuant to progressive oxidation and water condensate absorption of the nitrous gas during transport through the first and second channel systems of the second plates. In a nitric acid plant, the apparatus is connected to supplies of an oxidising gas, ammonia and water and connected in circuit with an oxidising system in which the steam-ballasted ammonia-oxygen feed from the core structure is subjected to high temperature catalytic conversion to nitrous gases for return to the core structure.

In one implementation, the first and second plates of the apparatus may comprise stainless steel plates.

In another embodiment, the apparatus for use in the production of nitric acid comprises a core structure comprising interleaved first and second groups of metal plates bonded in a face to face relationship. Each of the first plates is formed with separate first and second channel systems. Each of the second plates is formed with separate first and second channel systems that are juxtaposed in a heat exchange relationship with the first and second channel systems, respectively, of the first plates. The first and second channel systems of each of the second plates is connected serially in fluid passage communication. The apparatus further includes a header system for introducing ammonia, water, and oxidising gas to an inlet of the first channel systems of the first group of plates. In addition, an inlet for introducing a cooling medium to the second channel systems of the first group of plates is provided, and an outlet for removing cooling medium from the second channel systems of the first group of plates is provided. In one embodiment, the first channel systems of the first group of plates and the first channel systems of the second group of plates are operatively configured in a counter-flow relationship so that a hot nitrous gas feed received by the first channel systems of the second group of plates will heat a counter flowing aqueous ammonia-oxidising gas feed in the first channel systems of the first group of plates to form a steam-ballasted ammonia feed while simultaneously reducing the temperature of the nitrous gas feed to a temperature below its dew point. In addition, the effective length of the first and second channel systems in the second group of plates is preferably sufficient to oxidize nitrous gases in the nitrous gas feed to nitrogen dioxide and allow absorption of the nitrogen dioxide with condensed water from the nitrous gas feed to form nitric acid.

In one embodiment, the core structure further comprises a slot extending substantially between the first and second channel systems of the first and second groups of metal plates. In one embodiment of the apparatus, the effective length of the second channel system of the second group of plates is greater than that of the first channel systems of the second group of plates. In one embodiment, the effective length of the first and second channel systems in the second group of plates is sufficient for the oxidation process to run to substantial completion. In another embodiment, the effective length of the first and second channel systems in the second group of plates is set so that it is sufficient to form dilute nitric acid having a concentration of 20% to 40% (w/w).

In another aspect, a system for use in producing nitric acid, is provided. In one embodiment, the system comprises a heat exchanger apparatus comprising interleaved first and second groups of metal plates bonded in a face to face relationship. Each of the first plates is formed with separate first and second channel systems. Each of the second plates is formed with separate first and second channel systems that are juxtaposed in a heat exchange relationship with the first and second channel systems, respectively, of the first plates. The first and second channel systems of each of the second plates is connected serially in fluid passage communication. The heat exchanger also comprises a slot extending substantially between the first and second channel systems of the first and second groups of metal plates.

The system further includes a supply of ammonia, water, and an oxidising gas in fluid communication with an inlet of the first channel systems of the first group of plates, for providing an aqueous ammonia-oxidising gas feed to the first channel systems of the first group of plates. In addition, an ammonia oxidising system is provided in fluid communication with an outlet of the first channel systems of the first group of plates and an inlet of the first channel systems of the second group of plates. A cooling medium supply is provided in fluid communication with an inlet and an outlet of the second channel systems of the first group of plates.

In the system according to the instant embodiment, the first channel systems of the first group of plates and the first channel systems of the second group of plates are operatively configured in a counter-flow relationship so that a hot nitrous gas feed received by the first channel systems of the second group of plates from the ammonia oxidising system will heat the counter flowing aqueous ammonia-oxidising gas feed in the first channel systems of the first group of plates to form a steam-ballasted ammonia feed for the oxidising system while simultaneously reducing the temperature of the nitrous gas feed to a temperature below its dew point. The effective length of the first and second channel systems in the second group of plates is set to be sufficient to oxidize nitrous gases in the nitrous gas feed to nitrogen dioxide and allow absorption of the nitrogen dioxide with condensed water from the nitrous gas feed to form nitric acid.

In one embodiment, the system further comprises a gas cooling system in fluid communication with the oxidising system and operatively configured to cool the nitrous gas received from the oxidising system to a temperature above its dew point. In another embodiment, the system further comprises a separator interposed in fluid communication between the outlet of the first channel systems of the first group of plates and the ammonia oxidising system. In one embodiment the separator is operatively configured to remove excess aqueous ammonia from the steam-ballasted ammonia feed. In one embodiment, the system further comprises a pump operatively arranged to pressurize the supply above its combustion pressure. In another embodiment, the system further comprises a control valve interposed between and in fluid communication with the ammonia oxidising system and the inlet of the first channel systems of the second group of plates. In one implementation of the system, the effective length of the second channel systems of the second group of plates is greater than that of the first channel systems of the second group of plates.

In another embodiment a system for use in producing nitric acid is provided. The system comprises a heat exchanger apparatus comprising interleaved first and second groups of metal plates bonded in a face to face relationship. Each of the first plates is formed with separate first and second channel systems. Each of the second plates is formed with first and second channel systems that are juxtaposed in a heat exchange relationship with the first and second channel systems, respectively, of the first plates. The first and second channel systems of each of the second plates is connected serially in fluid passage communication.

The system further includes a supply of ammonia, water, and an oxidising gas in fluid communication with an inlet of the first channel systems of the first group of plates, for providing an aqueous ammonia-oxidising gas feed to the first channel systems of the first group of plates. In addition, an oxidising system is provided in fluid communication with an outlet of the first channel systems of the first group of plates and an inlet of the first channel systems of the second group of plates. The oxidizing system is operatively designed to oxidize ammonia within a steam-ballasted ammonia-oxidising gas feed received from the outlet of the first channel systems of the first group of plates to form predominantly nitrogen monoxide within a hot nitrous gas. Further, a cooling medium supply is provided in fluid communication with an inlet and an outlet of the second channel systems of the first group of plates.

In the system according to the instant embodiment, the first channel systems of the first group of plates and the first channel systems of the second group of plates are operatively configured in a counter-flow relationship so that the hot nitrous gas received by the first channel systems of the second group of plates will heat the counter flowing aqueous ammonia-oxidising gas feed in the first channel systems of the first group of plates to form the steam-ballasted ammonia feed for the oxidising system while simultaneously reducing the temperature of the hot nitrous gas to a temperature below its dew point. The effective length of the first and second channel systems in the second group of plates is selected to be sufficient given a designed flow rate of the hot nitrous gas to provide a residence time that is sufficient to oxidize nitrous gases to nitrogen dioxide and allow absorption of the nitrogen dioxide with condensed water from the nitrous gas to form nitric acid.

The invention will be more fully understood from the following description of an illustrative embodiment of an apparatus for use in the production of nitric acid. The description is provided by way of example with reference to the accompanying drawings.

### BRIEF DESCRIPTION OF THE DRAWINGS

In the drawings—

FIG. 1 is a schematic (fluid) circuit diagram of a complete nitric acid processing system,

FIG. 2 is a largely diagrammatic representation of a heat exchange apparatus that forms a part of the nitric acid processing system of FIG. 1,

FIG. 3 shows a channeled face of a first heat exchange plate of a core of the apparatus shown in FIG. 2,

FIG. 3A shows an enlarged view of a portion of the plate shown encircled in FIG. 3,

FIG. 3B shows an enlarged view of a further portion of the plate shown encircled in FIG. 3,

FIG. 4 shows a channeled face of a second heat exchange plate of the core of the apparatus shown in FIG. 2,

FIG. 4A shows an enlarged view of the portion of the plate shown encircled in FIG. 4,

FIG. 4B shows an enlarged view of a further portion of the plate shown encircled in FIG. 4, and

FIG. 5 shows graphs, of temperature against heat, that illustrate a typical operation of counter-flow feed effluent heat exchange in the heat exchange apparatus illustrated in FIGS. 2 to 4 and included in the schematic circuit diagram of FIG. 1.

### DETAILED DESCRIPTION OF THE ILLUSTRATIVE EMBODIMENT

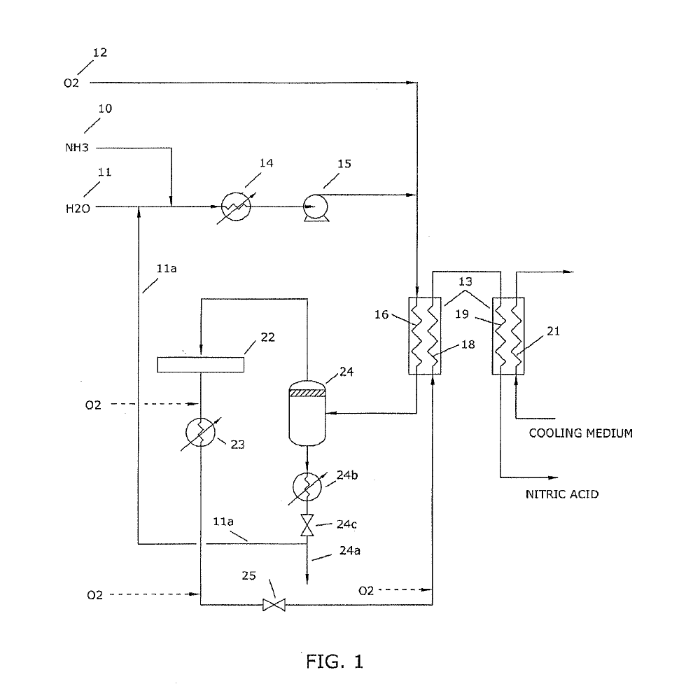

As illustrated in FIG. 1, the nitric acid processing system comprises sources 10, 11 and 12 of ammonia, water (or aqueous ammonia from a single source) and an oxidising gas such as oxygen, (all at about ambient temperature) which are streamed under pressure as an aqueous ammonia-oxygen “starting feed” to a feed-effluent heat exchange apparatus 13. The starting feed may be derived in various ways and, as shown by way of example in FIG. 1, the ammonia feed stream 10 at a pressure slightly above atmospheric may be dissolved in water from both the source 11 and a recycle stream 11a to form the aqueous ammonia stream. The mixing of the ammonia into the water to form the aqueous ammonia stream results in an exothermic reaction which causes the aqueous ammonia stream to be heated. The aqueous ammonia stream is cooled in a cooler 14 to about 60° C. and pressurised by a pump 15 to a pressure slightly above a combustion pressure, typically of about 2 bar (abs.).

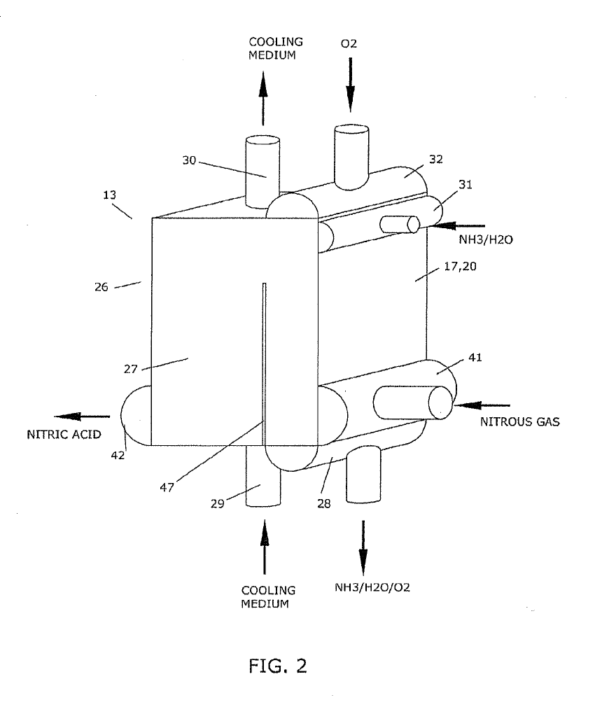

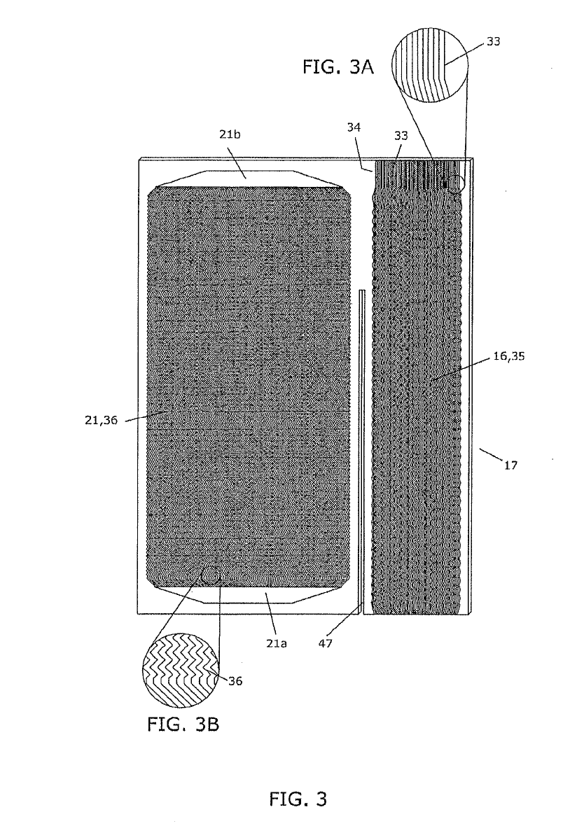

The aqueous ammonia-oxygen starting feed is delivered to a first channel system 16 of a first group of plates 17 (FIGS. 2 and 3) of the heat exchange apparatus 13. The aqueous ammonia-oxygen starting feed in passing through the heat exchange apparatus is heated to temperature levels which permit vaporisation of the ammonia and water, within the aqueous ammonia stream, into the oxygen stream. The resulting steam-ballasted ammonia-oxygen feed is delivered as a gaseous oxidiser feed to an oxidising system 22 in which the ammonia is oxidised to form, predominantly, nitrogen monoxide within hot (e.g., 800° C.) nitrous gas.

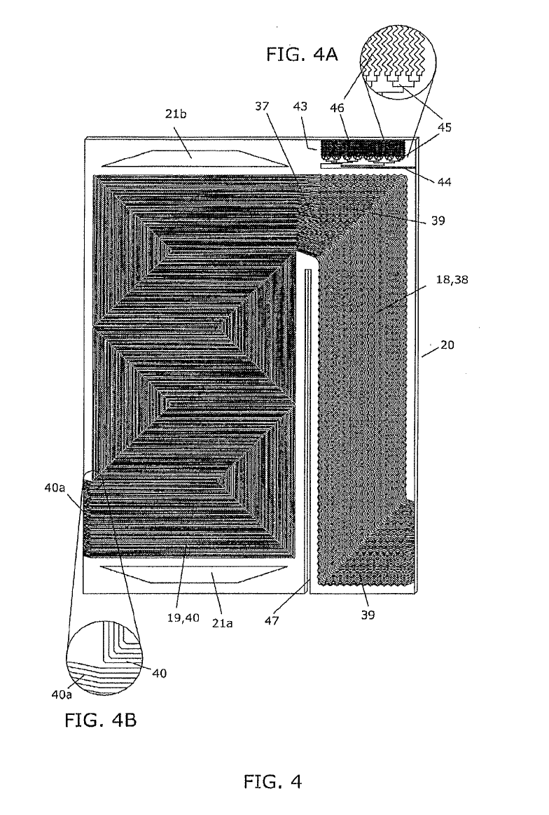

The nitrous gas feed from the oxidising system 22 is delivered at a reduced temperature (e.g., at about 140° C.) to series-connected channel systems 18 and 19 of a second group of plates 20 (FIGS. 2 and 4) of the heat exchange apparatus 13, in which the nitrous gas is further oxidised and absorbed by water condensate (derived from the starting/oxidiser feed) to produce dilute nitric acid.

The (relatively) high temperature nitrous gas feed through the channel system 18 exchanges heat with the counter-flowing aqueous ammonia-oxygen feed through the channel system 16. The resultant nitrous gas feed at reduced temperature (e.g., at about 60° C.) then exchanges heat, when flowing though the channel system 19, with the coolant medium (typically water) counter-flowing through a second channel system 21 of the first group of plates 17 of the heat exchange apparatus 13.

The quantity (flow rate) of oxygen that is delivered in the starting feed desirably is controlled such that it is sufficient to effect oxidation of all (or substantially all) of the ammonia and nitrous gas in the system. However, in a modification of the system the quantity of oxygen in the starting mixture may be controlled to oxidise all or substantially all of the ammonia and further oxygen may be added to the nitrous gas stream before water begins to condense from the reaction mixture in order to oxidise substantially all of the nitrous gas. Thus, the further oxygen may be admitted at any one or two or all of the three injection points shown by dashed outlines in FIG. 1.

Similarly, the quantity of water in the starting feed is controlled such that, when condensed out from the nitrous gas feed in the heat exchange apparatus 13 and reacted with (i.e., during absorption of) the derived nitrogen dioxide, the condensate is present in an amount sufficient to form dilute nitric acid having a concentration of the order of 20% to 40% (w/w). However, as is to be described below, excess aqueous ammonia may be added to the starting feed and be removed prior to delivery to the oxidising system 22.

The oxidising system 22 may comprise any type of ammonia oxidiser known in the art for use, for example, in high temperature catalytic conversion of an ammonia-oxygen mixture and, in such case, may employ any known type of catalytic system, including a cobalt oxide bed. In one suitable form it may incorporate a platinum-rhodium catalyst in the form of woven or knitted gauze layers. The steam-ballasted ammonia-oxygen feed to the oxidising system 22 is heated by a combination of conduction, convection and radiation to the reaction temperature by the catalyst layers and reacts on the catalyst layers to form the nitrous gas stream. The overall process is essentially adiabatic and the temperature reached, assuming complete, highly-selective conversion of ammonia to nitrogen monoxide, is primarily a function of the quantity of steam ballast present.

The nitrous gas feed at a temperature of the order of 800° C. from the oxidising system 22 is delivered to a quench boiler 23 of a conventional type known in the art and in which the gas feed is cooled to a temperature above the level of dew point (that is, to a temperature of the order of 140° C.). Steam may be raised in the quench boiler for delivery to a steam turbine (not shown) or for process heating independent of the system of the present invention.

The excess aqueous ammonia that, as above mentioned, is added to the starting feed is removed in a separator 24 (also of a conventional type known in the art) that is located in the feed stream to the oxidising system 22. The excess aqueous ammonia is added to the starting feed to avoid drying-out of feed through the first channel system 16 of the heat exchanger 13 and consequential build-up of solids/corrosion in the channel system.

The removed liquid may be exhausted from the system simply as a blow-down stream 24a from the separator 24, by way of a cooler 24b and a pressure reducing valve 24c, or (in the interest of minimising waste of aqueous ammonia feed) at least a major component of the removed liquid may be returned to the feed stream as the (above mentioned) recycle stream 11a. The blow-down stream 24a is provided for the purpose of avoiding excessive build-up of dissolved solid impurities within the recycling loop and the blow-down stream will typically comprise a small fraction (1% to 10%) of the feed water stream.

A control valve 25 is located in circuit between the quench boiler 23 and the nitrous gas feed to the heat exchange apparatus 13 for adjusting the pressure of the nitrous gas feed, for the purpose of regulating the amount of steam raised to provide the required degree of ballast.

As shown in FIGS. 2 to 4, the heat exchange apparatus 13 comprises effectively a solid core structure 26 that includes the two (first and second) groups of plates. That is, the core structure includes a plurality of the interleaved first and second plates 17 and 20 (forming the first and second groups respectively), the total number of which is determined by the production capacity required of the complete system. The plates are formed of a corrosion resistant metal, such as stainless steel, of thickness of the order of 1.6 mm, and all of the plates are diffusion bonded in face-to-face relationship between end plates 27. The second plates 20 are interleaved alternatingly with the first plates 17.

Each of the first plates 17 is formed with the (separate) first and second channel systems 16 and 21 and, as above described, the first channel systems 16 of the first plates are arranged as a group to receive (at their upper end, as viewed in FIG. 3) the starting feed of aqueous ammonia-oxygen. Also, the first channel systems of the first plates 17 are arranged as a group to deliver (from their lower end, again as viewed in FIG. 3) the steam-ballasted ammonia-oxygen feed to the separator 24 by way of a header 28.

As also described above, the second channel systems 21 of the first plates 17 are arranged as a group to be connected, via their lower and upper ends, in series with a coolant fluid supply by way of tubular ports 29 and 30. The coolant fluid is delivered to and conveyed from the channel systems 21 by way of passages 21a and 21b that are defined by window-like openings in all of the first and second plates 17 and 20.

Although not shown in FIGS. 3 and 4, the coolant fluid is directed into the passage 21a by way of an aperture that is bored into the bottom of the solid core 26 in alignment with the bore of the port 29. Similarly, the coolant fluid is directed from the passage 21b by way of an aperture that is bored into the top of the solid core 26 in alignment with the bore of the port 30.

The aqueous ammonia feed is delivered to the first channel systems 16 of the first plates by way of a header 31 and, in a manner to be described below, by way of a distribution system incorporated in the second plates 20. The oxygen component of the starting mixture is delivered to the first channel systems of the first plates by way of a header 32 and a plurality of linearly extending laterally spaced channels 33, each of which is etched to a depth of approximately 1.1 mm into an upper portion 34 of the first plates 17 in alignment with the first channel system 16.

The first channel system 16 of each of the first plates 17 comprises a plurality of laterally spaced longitudinally extending channels 35, each of which is etched to a depth of approximately 1.1 mm and each of which follows a zigzag path, similar to that illustrated on an expanded scale by channels 46 in FIG. 4A, along a major portion of its longitudinal length.

The second channel system 21 of each of the first plates 17 also comprises a plurality of laterally spaced longitudinally extending channels 36, each of which is etched to a depth of approximately 1.1 mm and follows a zigzag path.

Each of the second plates 20 (FIGS. 2 and 4) is formed with the separate first and second channel systems 18 and 19 that, when the plates are bonded to one another, are juxtaposed in heat exchange relationship with the first and second channel systems 16 and 21 respectively of the first plates 17. The first and second channel systems 18 and 19 of each of the second plates are connected adjacent their upper (as viewed in FIG. 4) ends serially in fluid passage communication by way of a series of laterally spaced linear channels 37, each of which is etched to a depth of approximately 1.1 mm and each of which connects one-to-one with channels in the first and second channel systems 18 and 19.

The first channel system 18 of each of the second plates 20 comprises a plurality of laterally spaced longitudinally extending channel portions (i.e., fluid passages) 38 and adjoining cross-flow channel portions 39. Each of the channel portions 38 and 39 is etched to a depth of approximately 1.1 mm and each of which follows a zigzag path, and the channel system 18 is patterned such that every channel portion has an effective length that is similar to every other channel portion throughout the aggregated longitudinal (38) and cross-flow (39) portions.

The second channel system 19 of each of the second plates 18 comprises a plurality of channel portions 40, each of which follows a straight or a zigzag path. The channel portions 40 alternate in direction, horizontally and vertically as viewed in FIG. 4 throughout their lengths and the individual channels are etched to a depth of approximately 1.1 mm. The total number of channel portions 40 within the second channel system 19 is the same as the total number of channel portions 38/39 within the first channel system 18. However, all of the channel portions 40 have a total effective length greater than that of the channel portions 38 and, thus, the area occupied by the channel system 19 is greater than that occupied by the channel system 18. The channel system 19 is patterned such that every channel portion 40 has an effective length that is similar to every other channel portion throughout the entire channel length extending between the connecting channels 37 and outlet connection channels 40a.

Hot nitrous gas is delivered to the lower end of the first channel system 18 of each of the second plates 20 by way of a header 41 and, following progressive oxidation and water condensate absorption of the gas, nitric acid is decanted from the lower end of the second channel system of each of the second plates by way of a header 42.

An upper portion 43 of each of the second plates 20 is positioned to correspond with the upper portion 34 of the first plates 17, and each of the second plates is provided with an etched laterally extending channel 44. The channel 44 communicates with the header 31 and receives the aqueous ammonia feed to be delivered to the first channel system 16 of each of the first plates 17.

The channel 44 connects into the first order of a four-order distribution system 45, which in turn feeds into the header 32, and thence into the first channel system 16 of each of the first plates 17, by way of channels 46. With this arrangement the three components (oxygen, ammonia and water) of the starting feed are distributed substantially evenly across the full width of the first channel system 16 of each of the first plates 17.

A slot 47 is provided in each of the first and second plates 17 and 20, together with the end plates 27, and it extends for approximately two-thirds of the height of the plates. The slot is provided to inhibit short-circuit conduction heat transfer from the hot end of the feed effluent exchanger, as referred to below, to the absorber as also referred to below.

It will be understood from the above description of the nitric acid processing system, as shown in FIG. 1, that the heat exchange apparatus effectively provides for a feed-effluent heat exchange system, comprising the first channel systems of the first and second groups of plates, integrated with an absorber heat exchange system that comprises the second channel systems of the first and second groups of plates. In the feed-effluent heat exchange system the two-phase feed of aqueous ammonia and oxygen is heated to a temperature which allows the feed stream to the oxidiser to carry the required amount of ballast steam. On the other side of the exchange, nitrous gas which is above the dew point enters the exchanger, is cooled to the dew point and further cooling is accompanied by condensation. Small amounts of nitrogen dioxide will be present in the incoming gas as a result of nitrogen monoxide oxidation in feed lines and the quench boiler prior to the feed-effluent heat exchange and, as the temperature and water content of the gas drop within the feed-effluent exchanger, the gas phase nitrogen monoxide oxidation accelerates and a rapidly increasing rate of acid formation will occur within the feed-effluent exchanger as the gases cool. Thus, it is not only water that condenses. In the absorber heat exchange system the process of nitrogen monoxide/nitrogen dioxide oxidation to nitric acid is completed. Coolant fluid lowers the temperature in the absorber to a level below that in the feed-effluent exchanger and the residence time of the nitrous gases in the absorber is, by design of the system, sufficient for the oxidation process to run to substantial completion.

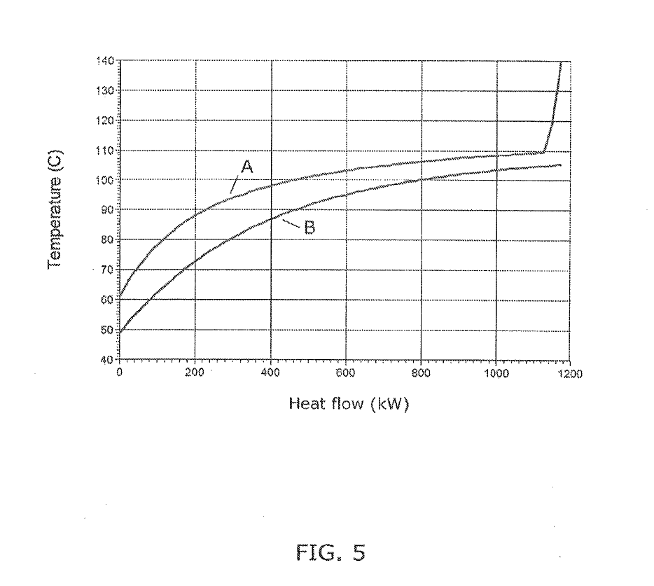

The graphs of FIG. 5, in showing temperature against heat, illustrate a typical operation of the counter-flow feed-effluent heat exchange that occurs between the first channel system 16 of the first plates 17 and the first channel system 18 of the interleaved second plates 20. Graph A is applicable to the reaction (nitrous gas) mixture in the first channel system 18 of the second plates 20 as it cools, with condensation of water, and Graph B is applicable to the feed stream undergoing (partial) evaporation of the aqueous ammonia during each pass.

Dimensions of the above described heat exchange apparatus will be determined by, for example, required acid production rates and volumes, as will be the flow rates of the various feeds to and from the apparatus. However, as an example only, with an ammonia feed rate of approximately 250 kg/h, a system operating pressure of 2 bar (abs.) and an oxidation temperature of approximately 800° C., the flow rates might typically be:

Water feed—1450 kg/h
Oxygen feed—1025 kg/h
Nitric acid delivery—2700 kg/h with 32% (w/w) concentration.

The plate/core dimensions might typically be as follows:

First and second plates—approximately 650 mm×600 mm×1.6 mm
Core thickness (i.e., stack height)—approximately 1.2 m, constituted by 350 first plates and 350 interleaved second plates.
Feed-effluent heat exchange area (total)—70 m²
Absorber heat exchange area (total)—160 m²

Each of the channel portions (i.e., fluid passages) within each of the plates is, in cross-section, formed as a semi-circle having a diameter of 2.2 mm and provides a cross-sectional flow area of approximately 1.90 mm².

Variations and modifications falling within the broad scope of the invention may be made in the apparatus as above described and defined in the following claims.

1-21. (canceled)

22. A apparatus for use in the production of nitric acid and which provides for feed-effluent heat exchange and integrated nitrogen dioxide absorption, the apparatus comprising a core structure comprising first and second groups of bonded corrosion resistant metal plates having fluid flow channel systems formed therein, with a feed-effluent heat exchange system comprising first channel systems of the first and second groups of plates juxtaposed in heat exchange relationship and an absorption system comprising second channel systems of the first and second groups of plates juxtaposed in heat exchange relationship.

23. A heat exchange apparatus as claimed in claim 22 wherein:
a) the first group of plates comprises a plurality of first said plates and the second group of plates comprises a plurality of second said plates, b) the first and second plates are bonded in face-to-face relationship with the second plates interleaved alternatingly with the first plates,
c) each of the first plates is formed with separate said first and second channel systems,
d) each of the second plates is formed with said first and second channel systems connected serially in fluid passage communication, and
e) the first and second channel systems of the second plates are juxtaposed in heat exchange relationship with the first and second channel systems respectively of the first plates.

24. A heat exchange apparatus as claimed in claim 22 wherein the first and second plates of each group of metal plates comprise stainless steel plates.

25. A heat exchange apparatus as claimed in claim 22 wherein all of the first and second plates of the first and second groups of metal plates are diffusion bonded to one another.

26. A heat exchange apparatus as claimed in claim 22 wherein the first channel system of each of the first plates is arranged to be connected to sources of ammonia, water (in liquid or gaseous form) and an oxidizing gas and to deliver a steam-ballasted ammonia-oxygen feed to an oxidizer system, and wherein the second channel system of each of the first plates is arranged to be connected in series with a coolant fluid supply.

27. A heat exchange apparatus as claimed in claim 26 wherein the first channel system of each of the second plates is arranged to be connected to a source of and to carry hot nitrous gas, and the second channel system of each of the second plates is arranged to deliver nitric acid when progressive oxidation and water condensate absorption of the nitrous gas occurs during transport through the first and second channel systems of the second plates.

28. A heat exchange apparatus as claimed in claim 22 wherein the first channel system of each of the first plates is constituted by a plurality of laterally spaced longitudinally extending channels, each of which is etched to follow a zigzag path along a major portion of its longitudinal length.

29. A heat exchange apparatus as claimed in claim 28 wherein the second channel system of each of the first plates is constituted by a plurality of laterally spaced longitudinally extending channels, each of which is etched to follow a zigzag path along the entirety of its longitudinal length and all of which connect with longitudinally spaced coolant fluid supply passages.

30. A heat exchange apparatus as claimed in claim 28 wherein the first channel system of each of the second plates is constituted by a plurality of laterally spaced longitudinally extending channel portions having adjoining cross-flow channel portions located at each end of the longitudinally extending portions, and wherein every channel portion has an effective length that is similar to every other channel portion throughout the aggregated longitudinal and cross-flow portions.

31. A heat exchange apparatus as claimed in claim 29 wherein the second channel system of each of the second plates is constituted by a plurality of channel portions which alternate in direction, horizontally and vertically throughout their lengths, wherein the total number of channel portions within the second channel system is substantially the same as the total number of channel portions within the first channel system in each of the second plates, and wherein all of the channel portions of the second channel system in each of the second plates have a total effective length greater than that of the first channel portions in the second plates, such that the area occupied by the second channel system is greater than that occupied by the first channel system.

32. A heat exchange apparatus as claimed in claim 22 wherein the first channel system in the first plates occupies approximately the same surface area as the first channel system in the second plates, and wherein the second channel system in the first plates occupies approximately the same surface area as the second channel system in the second plates.

33. A heat exchange apparatus as claimed in claim 22 wherein a slot is located in each of the first and second plates and positioned to inhibit short-circuit conduction heat transfer between portions of the first and second channel systems of the first and second plates.

34. A heat exchange apparatus as claimed in claim 30 wherein each of the second plates is formed at one end of, but spaced from, the first channel system in the first plates, with a laterally extending channel which connects with the first order of a multi-order distribution system which is connected in fluid passage communication by way of a header with the first channel system of the first plates.

35. An apparatus for use in the production of nitric acid and which comprises a core structure including a plurality of first and second corrosion resistant metal plates bonded in a face-to-face relationship, with the second plates being interleaved alternatingly with the first plates; each of the first plates being formed with separate first and second channel systems, with the first channel systems of the first plates being arranged to receive aqueous ammonia and an oxidizing gas and deliver a steam-ballasted ammonia-oxygen feed, and the second channel systems of the first plate being arranged to be connected in series with a coolant fluid supply; each of the second plates being formed with separate first and second channel systems that are juxtaposed in heat exchange relationship with the first and second channel systems respectively of the first plates; with the first and second channel systems of each of the second plates being connected serially in fluid passage communication, and with the first channel systems of the second plates being arranged to receive hot nitrous gas and the second channel systems being arranged to deliver nitric acid pursuant to progressive oxidation and water condensate absorption of the nitrous gas during transport through the first and second channel systems of the second plates.

36. The apparatus as claimed in claim 35, which is able to be connected to supplies of an oxidizing gas, ammonia and water and is able to be connected in circuit with an oxidizing system in which the steam-ballasted ammonia-oxygen feed from the core structure is subjected to high temperature catalytic conversion to nitrous gases for return to the core structure.

37. The apparatus as claimed in claim 36 wherein the first and second plates comprise stainless steel plates.

38. The apparatus as claimed in claim 35 wherein the first and second plates comprise stainless steel plates.

39. An apparatus for use in the production of nitric acid, the apparatus comprising:
a core structure comprising interleaved first and second groups of metal plates bonded in a face to face relationship, each of the first plates being formed with separate first and second channel systems, each of the second plates being formed with separate first and second channel systems that are juxtaposed in a heat exchange relationship with the first and second channel systems, respectively, of the first plates, the first and second channel systems of each of the second plates being connected serially in fluid passage communication;
a header system for introducing ammonia, water, and an oxidizing gas to an inlet of the first channel systems of the first group of plates;
an inlet for introducing a cooling medium to the second channel systems of the first group of plates; and
an outlet for removing cooling medium from the second channel systems of the first group of plates;
wherein the first channel systems of the first group of plates and the first channel systems of the second group of plates are operatively configured in a counter-flow relationship so that a hot nitrous gas feed received by the first channel systems of the second group of plates will heat a counter flowing aqueous ammonia-oxidizing gas feed in the first channel systems of the first group of plates to form a steam-ballasted ammonia feed while simultaneously reducing the temperature of the nitrous gas feed to a temperature below its dew point; and
the effective length of the first and second channel systems in the second group of plates is sufficient to oxidize nitrous gases in the nitrous gas feed to nitrogen dioxide and allow absorption of the nitrogen dioxide with condensed water from the nitrous gas feed to form nitric acid.

40. An apparatus for use in the production of nitric acid according to claim 39, wherein the core structure comprises a slot extending substantially between the first and second channel systems of the first and second groups of metal plates.

41. An apparatus for use in the production of nitric acid according to claim 39, wherein the effective length of the second channel systems of the second group of plates is greater than that of the first channel systems of the second group of plates.

42. An apparatus for use in the production of nitric acid according to claim 39, wherein the effective length of the first and second channel systems in the second group of plates is sufficient for the oxidation process to run to substantial completion.

43. An apparatus for use in the production of nitric acid according to claim 42, wherein the effective length of the first and second channel systems in the second group of plates is sufficient to form dilute nitric acid having a concentration of 20% to 40% (w/w).
